(19) United States
(12) Patent Application Publication
(10) Pub. No.: US 2006/0059458 A1
(43) Pub. Date: Mar. 16, 2006

(54) Creating software applications

(75) Inventor: Michael J Plummer, Redhill (GB)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics, N.V., Eindhoven (NL)

(21) Appl. No.: 10/532,923

(22) PCT Filed: Oct. 14, 2003
(86) PCT No.: PCT/IB03/04525

§ 371 Date: Apr. 27, 2005

(30) Foreign Application Priority Data
Oct. 29, 2002 (GB) 0225097.5

(51) Int. Cl. G06F 9/44

(52) U.S. Cl. 717/108; 717/114; 717/116

(57) ABSTRACT

A method of coordinating a software application for execution on a target device, the application comprising a set of pre-compiled, re-useable components and corresponding configuration data. The configuration data (108) is made available to a target device on which the application is to be run. For each component comprising the application, relevant configuration data is determined (110) and an instance of the component is instantiated (112) and configured (116) in dependence on the configuration data. The execution (120) of the application is at least partly determined by the interaction of the configured instances of the components.

The present invention relates to the field of software development and in particular to the development of software applications by those who are specialists in the applications rather than in the software.

Consumers buying CE products such as a set top box (STB), TV, VCR, DVD, personal video recorder (PVR), audio and the like have come to expect rich sets of features. Typically software is used as a means to offer such features at an acceptable price. Unlike users of PCs, consumers of CE products are not tolerant to software bugs or crashes and so software in such products needs to work robustly every time. This means more testing which in turn raises software development costs; manufacturers have tended to reuse software code across a number of product ranges or lines in order to maximise return on this investment. The trend to shorter product lifetimes makes this type of re-use (as a means of unit cost reduction) less feasible. In addition, products like STB may be sold as gateways to enable consumers to access more than one service provider. In the case where each service provider requires its own ‘house style’ or other ‘look and feel’, the goal of using common software for all service providers is more difficult to achieve.

One approach to ease this problem is to develop software at a higher level of the application, for example by writing code which references pre-written lower level software modules each of which may deal with a more detailed aspect of the overall application. One example is described in U.S. Pat. No. 6,028,998, to Gloudeman et al., which discloses an application framework for constructing building automation systems, which framework provides a library of standard objects, assemblies and smaller function-specific applications that can connect together to build more complex systems. The application framework embeds the knowledge and best practices of experienced designers, allowing less experienced software developers to build systems. A disadvantage of this system is that additional software has to be written to connect together the standard objects. The overall program, comprising such software, requires rigorous testing to ensure robustness—such requirement is compounded by the fact that the system is inherently complex resulting in potentially high testing costs. Furthermore, a minor change made subsequently, for example adding another feature (such as an instance of a standard object), would require the testing of the entire application to be performed once again.

An example of re-useable software components is JavaBeans™ (an Object Oriented Programming (OOP) interface from Sun Microsystems Inc. of Santa Clara, USA) which makes Java™ classes easier to use as re-useable software components. Java™ is attractive to providers of services intended to be run on CE products since it is portable and architecture neutral allowing it to be downloaded and run on any vendor's hardware. JavaBeans™ (or Beans) are created by writing a program using the Java™ programming language and including JavaBeans™ statements to for example describe properties such as user interface (UI) characteristics or events to trigger the Bean to communicate with other Beans. As described in “A walking tour of JavaBeans”, JavaWorld, August 1997, when a developer is connecting Beans together to create an application, the Integrated Development Environment (IDE) can present a property sheet containing all the Beans' properties and their current values. (A property sheet is a dialog box used to set and/or view properties using, for example, a menu.) The developer sets the properties graphically, which the IDE translates into calls to the Beans' setter methods, changing the Beans' state. This customizes the Beans for the particular application. Thus use of JavaBeans™ to build applications requires an IDE system to create and compile code at design time to ensure connected Beans suitably co-operate. Assuming the application functions satisfactorily, testing (e.g. to test for bugs or program crashing) of the finalised application program is nevertheless still required. In addition, costly Java™ programmers are required to develop the applications themselves (that is, connect the Beans together).

As described in Internet documents published by Carnegie Mellon Software Engineering Institute (http://www.sei.cmu.edu/str/descriptions) re-useable software components must be integrated through some well-defined infrastructure. This infrastructure provides the binding that forms a system from the disparate components. An object request broker (ORB) is a middleware technology that manages communication and data exchange between objects. It has an advantage in that object communication details are hidden from the developers and isolated in the ORB, potentially making the system more maintainable. A disadvantage of ORB technology is that it requires objects wishing to communicate to have visible (readable) data and well defined Application Programming Interfaces (APIs). The need to define and possibly standardise such data and APIs can slow down product development. Furthermore, the code size of an ORB compatible object plus the ORB code itself may be large, a factor which is of particular concern in CE products which tend to have limited capability to store, download and/or process such code.

Service Providers operating in the CE marketplace need to build and maintain their brands and be dynamic to compete—this creates a need to develop applications which rapidly address changing market trends and retain the look and feel of the Service Provider; furthermore, the effective lifetime of an application will be short. Both these requirements mean that applications must be quickly developed and at low cost; such applications of course must also be robust in use. For some prior art methods, including those outlined above, application development comprises the sequential tasks of application requirements capture followed by implementation by software experts (e.g. programmers) to ensure robustness of the application (e.g. that it has few bugs or rarely crashes); disadvantages of such methods may include slow development and/or poor performance (e.g. due to the necessary cooperation of application experts and programmers, testing, etc.) and cost (e.g. expense of programmers). A further disadvantage is that apparently very similar applications cannot readily exploit common software code without jeopardising robustness.

It is an object of the present invention to provide a solution to these and other problems by means of a method to create software-based applications utilising two or more re-useable software components.

In accordance with the invention there is provided a method of coordinating an application for execution within a software controlled apparatus, the application comprising a plurality of pre-compiled re-useable components and where at least one of said components has at least one configurable property, the method comprising the steps of:
accessing configuration data relating to the plurality of pre-compiled components; and, for each component:
   determining configuration data corresponding to the component;
   creating an instance of the component;
   and, where the component has at least one configurable property:
   configuring the instance of the component by configuring its properties in dependence on the configuration data;
   such that execution of the application is at least partly determined by the interaction of the configured instances of the components.

When creating applications, re-use of software code is seen as a potential means to reduce overall cost. The present invention allows an application to employ blocks of pre-written and tested code in the required combinations without degrading the robustness of execution of the code. In this way, effort and cost expended developing and testing a block of code may not be lost when utilising the block of code within one or more applications. This contrasts for example with an application built using JavaBeans whereby additional code is necessary to suitably link the Beans together (that is, customise their properties). Such code has the potential to make the overall application less robust to bugs and crashes and/or to prevent the application being built except by those who are suitably skilled in programming.

To facilitate its use in an application, a block of software code may offer one or more capabilities or properties which may be configurable in one or more ways appropriate to the needs of the application. Such properties may affect a functional or other aspect of the operation of the code, including, but not limited to, initialisation, user interface (UI), actions and communication (for example with other components or interfaces). Such a block of code is hereinafter termed a component and is pre-built (that is, constructed prior to developing an application, for example by coding and/or compilation) and may be configurable. In the context of the present invention a pre-built component is re-useable in that it is able to be incorporated into various applications without first having to be re-built for each such application. A particular aspect of the present invention is that the configuration of a component may be achieved without writing or compiling additional software code (that is, code in addition to that comprised in the components). To do this a component may determine configuration data in order to perform, at least partially, a configuration of itself. For example, it may be arranged to access configuration data within one or more files by one or more components comprising an application; in response, configuration data relating to one of the components may be recognised and an instance of the component created and then configured according to the data, for example by the component loading or in any other way acting on the data to perform one or more configuration tasks according to the data. Following the present invention, an application may be created by suitably combining two or more such configured components, which configuration may enable the components to co-operate according to the requirements of the application. The components may be arranged in an archive file including, but not limited to, a Java Archive (JAR) file or a ZIP file. The archive file may then be made available to a software controlled apparatus (e.g. a target platform) on which the application is to be run.

The method of the present invention may be used with components written in any suitable programming language. Preferably components are written in the Java™ language, that is pre-written Java™ classes. The consequent Java™ applications created by combining suitably configured Java™ components include, but are not limited to, applets, Xlets and servlets.

In accordance with a further aspect of the invention there is provided a method of developing an application comprising the steps of:
accessing a suite of pre-compiled re-useable components;
selecting an interaction between at least two of the components, wherein at least one of said components has a configurable property;
configuring the or each property in dependence on the selected interaction; and
generating configuration data in dependence on the configured properties, such that instances of said at least two components, configured in dependence on the configuration data, are enabled to perform said selected interaction.

An application may comprise the co-operation of one or more pre-compiled components. To develop a new application, suitable components are chosen which may individually and/or by mutual interaction provide the requisite functionalities. At least one of these chosen components comprises a configurable property, the configuration of which may for example determine the interaction of the component with another component. Therefore, the property of a component may be configured to suitably provide a desired function. As a consequence, configuration data may be generated and be made available to configure an instance of the component on a target platform in order to implement the desired functionality (e.g. component interaction).

The configuration data may be structured in any suitable form to be read by the one or more components to which it relates, the file structure may include, but not be limited to, an array, a linked list, a data map, an XML script or ASCII text. In use, the application comprising the configured instances of pre-written and pre-compiled components may be run on a suitable target platform, including, but not limited to, PC, MAC, consumer electronics products (TV, VCR, DVD, STB, PVR, etc.) and internet appliances. For a given application, a platform may access the configuration data and a requisite set of pre-compiled components via local storage (e.g. ROM, RAM, Hard Disk Drive—HDD), a record carrier (e.g. Floppy Disk Drive—FDD, optical disc) and/or via remote access, for example from a network or the internet (using Ethernet or modem e.g. dial-up, broadband, cable, etc.) or any combination of these. Configuration data related to an application may comprise any combination of the identities of components utilised to implement the application, data to configure the components and navigational data. In accordance with the configuration data, the software running on the platform may arrange for appropriate components to instantiated, configured and run in order to execute the application.

To develop a component for use with the method of the invention, one or more configurable properties of the component may be defined, the properties being defined to be configurable according to configuration data accessible by the component. By suitable coding and compilation, the component may be arranged to access configuration data and configure one or more of its configurable properties. In this way, a robustly operating yet functionally flexible component may be realised. A suite of such components may be built to suitably co-operate in various combinations to yield a variety of robust applications wherein each application requires no additional code to be written. Optionally, by defining an additional suitable API for the components, it may be possible for vendors or advanced users to add additional components to an application to further enhance capability.

Any suitable tool may be employed to develop applications according to one aspect of the method of the invention. Furthermore, such tools may use any appropriate language—that is, not limited to the language or languages used by the application components. As an example, the capabilities of a suitable tool may include:
a library comprising references to a suite of pre-compiled components;
user interface to allow an application developer:
   to select pre-compiled components from the library;
   to be offered possible interactions between selected components;
   to select one or more interactions (based on desired functions) from those offered;
   to construct the application and review its functionality;
a configuration program:
   to configure properties and interactive behaviour of selected components in dependence on the selected interaction;
   to generate configuration data in dependence on the configured properties.

From the foregoing a method according to the present invention enables applications to be created by developers who are not expert at software programming, or even have no programming ability, since the applications comprise existing pre-compiled software components suitably combined but without the need for additional software coding and/or compilation. This has several benefits—application development can be performed by experts who best understand the application; such experts (for example graphics designers) are also likely to be less costly than programmers; re-use of software components is facilitated allowing applications to be built more quickly since only testing at a functional level of the application may be required. As a consequence, applications are robust, particularly in not increasing the likelihood of software bugs and/or crashes. The constituent components themselves can be developed, optimised and tested by experienced software programmers. This in turn may allow an application to achieve a certain overall program size (e.g. compactness) and/or speed, aspects which in the envisaged CE and similar applications are deemed important—for example the ability to readily transfer an application over a low speed network or to store and run the application on a target platform with modest storage and processing capability is highly valued.

Further features and advantages will now be described, by way of example only, with reference to the accompanying drawings in which:

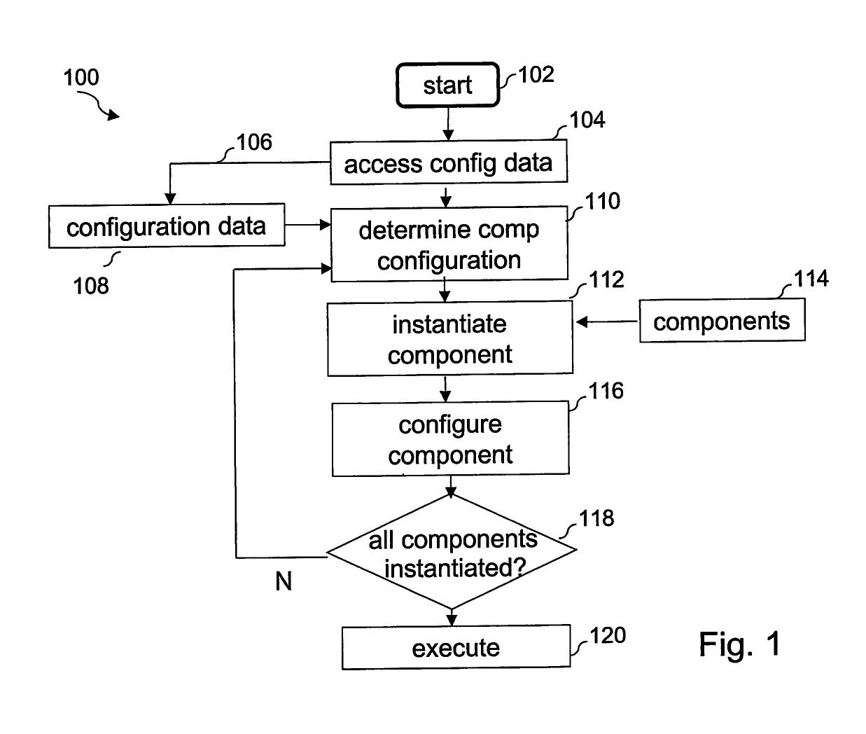

FIG. 1 is a flow diagram of an exemplary method embodying an aspect of the invention;

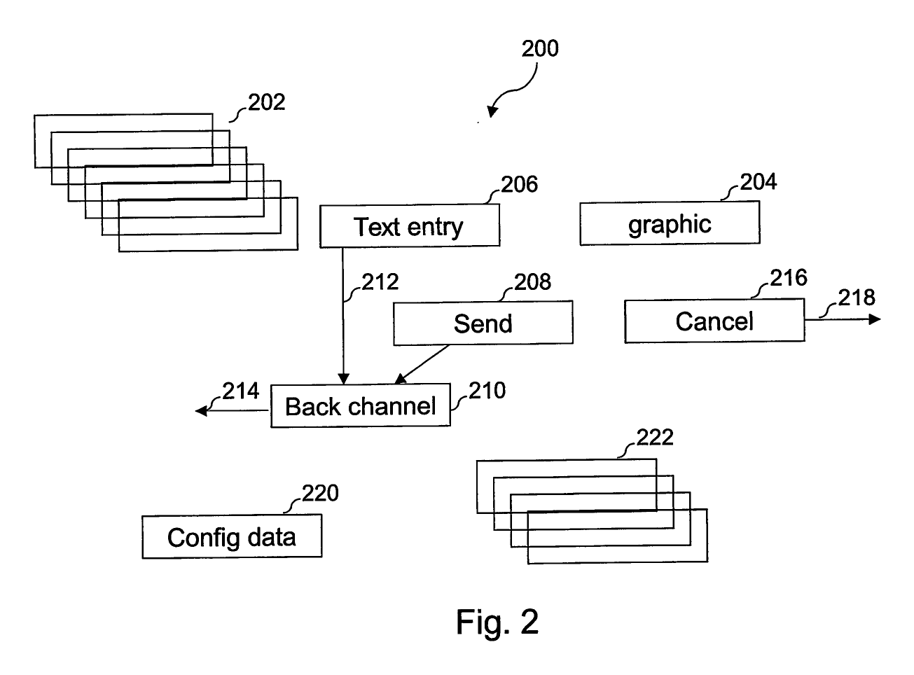

FIG. 2 is a schematic representation of a simple application developed using a configuration tool;

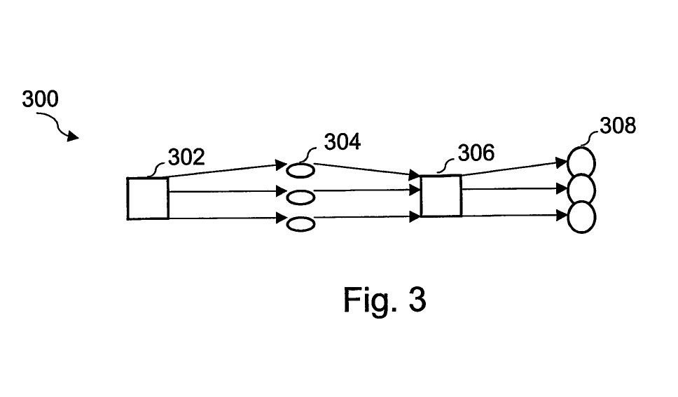

FIG. 3 is a schematic representation showing an overall process to create and execute an application; and

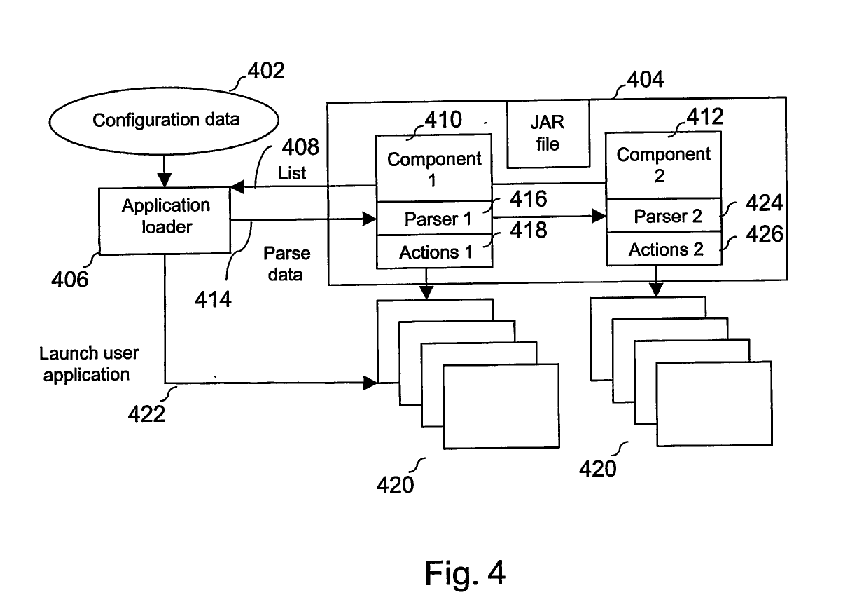

FIG. 4 is a schematic representation showing an example of the configuration of a Java™-based application.

In the following description, the term ‘configuration data’ comprises data which identifies a software component and may also determine the configuration of one or more properties of the component.

FIG. 1 shows a flow diagram of an exemplary method embodying an aspect of the invention. The method is shown generally at 100 and describes a process of coordinating an application for execution within a software controlled apparatus. The method starts at 102 and configuration data is accessed at 104. For an apparatus there may be a variety of sources from which to access this data including, but not limited to, local non-volatile storage (e.g. ROM, HDD), a record carrier (e.g. FDD, CD-ROM, Zip-drive, memory card) or a data file located on a network or an Internet Website. The configuration data may comprise the identities of the components used in one or more applications and data to configure the properties thereof. In practice, the configuration data may reside within one or more files which may also contain references to other assets (for example video, audio, graphics, text, etc.) to be used by the application; a configuration data file may be defined for the entire application or for a part or parts thereof, for example where a collection of similar functions and interactivity is located. The accessed configuration data 106 may be stored at 108. Next, for each application component identified, the configuration is determined 110 and an instance of the component is instantiated 112 by reference to a component library 114. The component library may comprise one or more stores located locally and/or remotely to the apparatus; for example, the library may comprise popular (e.g. common to many applications) components stored in local non-volatile storage (ROM, HDD, etc.) plus other components stored remotely on a network. Components may be accessible by the target in the form of one or more archive files including, but not limited to, JAR or ZIP files. Components or archive files may be downloadable from a network or the Internet, or otherwise delivered by any suitable means such as a record carrier, in similar fashion to the configuration data discussed earlier. The instantiated component may then be configured 116 (noting that a particular component of the application may or may not require configuration). The method may then loop 118 to ensure that all components required by the application are instantiated and configured. Once this has been achieved, the application is ready to execute 120—for example, the configuration data of the application may indicate which component should be given initial focus when the application is run.

FIG. 2 shows a schematic representation of a simple application developed using a configuration tool. The application components are shown generally at 200. A configuration tool would be used by for example a graphics designer to develop the application. It is to be noted that the tool itself may be constructed using any suitable programming language, not just the language or languages used by the application (that is, by the components utilised by the application). Functionally, the tool may include or otherwise access a suite or palette 202 of available components from which the designer could select for use by the application. An example of how a configuration tool process might work is the creation of an MHP (Multimedia Home Platform) interactive TV application based on pre-compiled Java™ classes (components); the application comprising an advertising graphic, a text entry means to enter an email address to obtain further information and Send and Cancel buttons. The designer might use the configuration tool to load and position a graphics component 204 and load the appropriate advertising graphic file into it (not shown in FIG. 2). Next, a text entry field component 206 may be added and have its properties configured for size, font, etc. Then the designer may add two button components 208, 216 which would be labelled Send and Cancel. The Send button 208 might interact with a further component 210 which handles communication with a back channel by having a “Call Back Channel” action in its action list. The back channel component 210 may have a Send Text Field action in its action list that arranges for the contents 212 of the text entry field to be sent down the back channel 214. The Cancel button 216 might have an exit action in its action list so as to exit 218 the application. The tool may offer the designer the facility to exercise (e.g. by simulation) the application to test for correct interaction between the components. Once the application had been developed, the configuration data 220 corresponding to the application may be output and the appropriate components used by the application (including application core, graphic, text entry, button and back channel) may be archived in a JAR or ZIP file 222. The configuration data in any suitable way may be made available to the target platform via for example, but not limited to, local storage, record carrier, network or Internet. Similarly, the components (e.g. the JAR or ZIP file) may also be made available via one or more of these (but not necessarily the same) mechanisms. The configuration tool may generate several configuration data and/or JAR or ZIP files for an application. It will be apparent to the skilled person that these files can be made available to the target in any combination of the above mechanisms.

A more detailed example embodying aspects of the invention is described below. The example concerns a consumer electronics device (for example a STB, PVR, etc.) which is used to receive digital television services (e.g. related to Multimedia Home Platform, MHP) from several service providers, the device itself being a standardised product preloaded with a suitable Java Virtual Machine (JVM) and a Java™ application created according to the method of the invention as described earlier. In practice, the Java™ application might be incorporated as part of the firmware of the CE device. The components used by the Java™ application may have been assembled in a JAR file using a configuration tool as described above.

Each service provider has produced (e.g. using its in-house graphics designers) its own configuration data, so that when the Java™ application is run the configuration data might for example arrange and configure the navigation and look and feel of the Graphical User Interface (GUI) of the Java™ application according to the requirements of the service provider. For instance, one provider might wish to start the service with a splash screen advertising their services, whereas another might wish to go directly to an Electronic Programme Guide (EPG) while a third might wish to start with breaking news information. FIG. 3 shows a schematic representation of an example process to create configuration data for a common Java™ based application. The process is shown generally at 300 and comprises a configuration tool 302 used by a service provider to generate configuration data to configure a common application 306. Similarly, other service providers generate configuration data for the common application. The set of configuration data 304 corresponding to the service providers is made available to configure the common Java™ application 306. To implement a user application 308 for a particular service provider, configuration data 304 corresponding to that service provider configures an instance of the application 306. It may be possible to run more than one instance of the application simultaneously on the CE device such that a user may be able to seamlessly switch between service providers without delay or loss of the customised look and feel or other aspects of the configured application specific to each provider.

The configuration data may be downloaded when a connection is first made to the CE device and then stored in non-volatile memory (e.g. flash memory, HDD, etc.). However, if the service provider wishes to provide a different user application or update some data (e.g. an EPG) then a new version of the configuration data could be downloaded and the Java™ application restarted with the new data (or if the configuration data is based on one file per page, just the appropriate objects are updated as necessary). Thus some user applications may change infrequently while others may change in real-time (e.g. digital Teletext services). The components used in such a user application could be, for instance, a back channel connection (via phone or cable), text entry widgets, bitmap images, etc., or they could be something more complicated such as a complete EPG. In any case, their appearance and way of working would depend on the actual configuration data.

FIG. 4 is a schematic representation showing an example of the configuration of a Java™-based application. The context is the configuration of an application residing in a target apparatus, for example a set top box. Configuration data 402 is made available to the target apparatus. The Java™ application is contained in one or more JAR files 404, and comprises components 410, 412 selected (when the application was created) by a configuration tool. An application loader class (component) 406 reads the configuration data 402 and determines the components required for the user application which should correspond with the components available in the JAR file or files. The loader then initiates parsing 414 of the configuration data and forwards the parse data 414 to the first required component 410 of the JAR file. The component parses 416 the parse data as a static method; having found a corresponding data set, the static method creates an instance of the component and configures its properties according to the data. Actions 418 carried out on or by the instance of this component are also determined according to the configuration data. Remaining parse data 414 is then forwarded to the remaining components (in this example just component 412) for parsing until all required components have been instantiated and configured and actions determined. In similar fashion to component 410, in respect of component 412 the parse data is parsed 424, an instance of the component is created and actions 426 carried out on or by the instance of the component are determined. A list 408 of all instantiated components 420 is returned to the application loader 406. Finally the loader starts the application running 422 by whatever means is used by the target platform.

A component which supports the present invention may have the following elements:—
a method to create a new instance of itself;
a parsing method to receive configuration data passed to it by the application loader that will only act on relevant tokens and passes the remainder to the next component;
a method for each instance to configure itself from the parsed data and gather parameters for actions to be performed by itself; and
a method or methods that will implement actions carried out on or by instances of this component including methods of navigation. The whole list of these instances and associated methods may constitute an application.

The foregoing methods and implementations are presented by way of example only and represent a selection of a range of methods and implementations that can readily be identified by a person skilled in the art to exploit the advantages of the present invention.

In the description above and with reference to FIG. 1 there is disclosed a method of coordinating a software application for execution on a target device, the application comprising a set of pre-compiled, re-useable components and corresponding configuration data. The configuration data 108 is made available to a target device on which the application is to be run. For each component comprising the application, relevant configuration data is determined 110 and an instance of the component is instantiated 112 and configured 116 in dependence on the configuration data. The execution 120 of the application is at least partly determined by the interaction of the configured instances of the components.

1. A method of coordinating an application for execution within a software controlled apparatus, the application comprising a plurality of precompiled re-useable components and where at least one of said components has at least one configurable property, the method comprising the steps of:
accessing (104) configuration data relating to the plurality of pre-compiled components; and, for each component:
determining (110) configuration data corresponding to the component;
creating (112) an instance of the component;
and, where the component has at least one configurable property:
configuring (116) the instance of the component by configuring its properties in dependence on the configuration data;
such that execution (120) of the application is at least partly determined by the interaction of the configured instances of the components.

2. A method as claimed in claim 1, wherein configuration data corresponding to a component is determined at least partly by the component.

3. A method as claimed in any of the claims 1 to 2, wherein the components are made available to the apparatus as an archive file.

4. A method as claimed in any of claims 1 to 2, wherein the configuration data is at least partly accessed from local storage.

5. A method as claimed in any of claims 1 to 2, wherein the configuration data is at least partly accessed from a record carrier.

6. A method as claimed in any of claims 1 to 2, wherein the configuration data is at least partly accessed from a network.

7. A method as claimed in claim 6, wherein the configuration data is at least partly accessed from the Internet.

8. A method of developing an application comprising the steps of:
accessing a suite of pre-compiled re-useable components;
selecting an interaction between at least two of the components, wherein at least one of said components has a configurable property;
configuring the or each property in dependence on the selected interaction; and
generating configuration data in dependence on the configured properties,
such that instances of said at least two components, configured in dependence on the configuration data, are enabled to perform said selected interaction.

9. A method of developing a pre-compiled re-useable component for use in the method of claim 8, the method comprising the steps of:
defining a property of the component, which property is configurable in dependence on configuration data;
coding the component, which coding is operable to access said configuration data and to configure the configurable property of the component in dependence on said configuration data; and
compiling the component.

10. A pre-compiled re-useable component produced by the method of claim 9.

11. A method according to any of the claims 1, 2, 8 or 9, wherein a component is a pre-written Java class.

12. A record carrier comprising software operable to carry out the method of any of the claims 1, 2, 8 or 9.

13. A software utility configured for carrying out the method steps as claimed in any of the claims 1, 2, 8 or 9.

14. A computer apparatus including a data processor, said data processor being directed in its operations by a software utility as claimed in claim 13.

15. A method of coordinating an application for execution within a software controlled apparatus substantially as hereinbefore described and with reference to the accompanying drawings.
